(19) United States
(12) Patent Application Publication
(10) Pub. No.: US 2006/0212159 A1
(43) Pub. Date: Sep. 21, 2006

(54) Cut-off unit with constant chip volume cutting for machine tools

(75) Inventors: Antonio Battistella, Brendola (VI) (IT); Riccardo Campion, Brendola (VI) (IT); Giuseppe Fin, Brendola (VI) (IT); Marco Gabrielli, Brendola (VI) (IT)

Correspondence Address: John S. Egbert;Egbert Law Offices, 7th Floor, 412 Main Street, Houston, TX, 77002, US

(73) Assignee: SINICO SPA, Brendola (VI) (IT)

(21) Appl. No.: 11/369,200

(22) Filed: Mar. 6, 2006

Related U.S. Application Data
(63) Continuation-in-part of application No. 10/214,953, filed on Aug. 8, 2002, now abandoned.

(30) Foreign Application Priority Data
Sep. 7, 2001 (IT) TV2001A000121

(51) Int. Cl. G06F 19/00

(52) U.S. Cl. 700/175; 700/173

(57) ABSTRACT

The present invention is a cut-off unit with constant chip volume cutting for machine tools. The cut-off unit maintains a constant chip volume during cutting, which stabilizes friction between the blade of the cutting disk, the teeth of the cutting disk and the chips in between the teeth. In this manner, the working life of the blade and the speed metal bars at the cut-off unit can be controlled for extending the working life of the blade and for increasing the efficiency of time required for cutting or shearing at the cut-off unit. Advancement speed of the cut-off unit, which is guided by a logic-control unit, is continuously and regularly adapted, to keep the volume of chip cut away and accumulated in each gap between the teeth of the blade constant. When cutting a bar, the advancement speed will be higher at the beginning and at the end of the cut, and lower in the central part.

### RELATED U.S. APPLICATIONS

The present application is a continuation-in-part of U.S. application Ser. No. 10/214,953, filed on Aug. 8, 2002, and entitled “CONSTANT CHIP VOLUME CUTTING SYSTEM FOR MACHINE TOOLS”, presently pending.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention relates to a cut-off unit with constant chip volume cutting for machine tools. The cut-off unit is part of a machine tool, the machine tool being used in the automatic machining of tubular and solid metal bars.

### BACKGROUND OF THE INVENTION

The machining of metal bars is widely performed. It usually involves the end of the metal bar being machined, such as the metal bar being squared off, being internally or externally chamfered, and/or being internally or externally threaded, etc.

Since the work is automated, the metal bars to be machined, either tubular or solid, are usually loaded into a machine tool for the machining. Therefore, a first step of processing the metal bars to be carried out is to either cut or shear the metal bar at a cut-off unit. The metal bar is to be later machined in various ways.

The various machining steps are carried out on fixed work stations. The metal bar to be machined is transferred cyclically to each fixed work station by a rotating table, also known as a transfer table.

As described previously, the first step of processing is the cutting of metal bar, being either tubular or solid. Once the cutting has been completed, the rotating table, to which the cut metal bar is affixed, is able to transferred the metal bar to other peripheral stations for successive processing, for example, a threading station and a squaring off station.

In order to obtain the highest productivity possible, the common goal of the manufacturers of automatic machine tools is to reduce the time required for the various operations to a minimum. In particular, the cutting or shearing of the bar as described above at the cut-off unit is carried out before all the other operations. It is a solution of the present invention to reduce the time required for cutting or shearing at the cut-off unit.

However, reducing the time required for cutting or shearing typically means that the working life of the cutting tool is reduced. The cutting tool of the present invention is a disk-type cutter or cutting disk. Therefore, because of the costs involved for the purchase and replacement of a blade on the cutting disk, and the resulting down times of the entire machine tool in order to carry out the complete operation, it has become indispensable to identify work techniques aimed at reaching the best compromise between the working life of the blade and the time required for cutting or shearing.

The blade of a cutting disk is comprised of a series of teeth or cutters, situated around the circumference at a certain pitch, and in most cases the pitch is constant.

One of the main causes of wear to the blade is the vibration induced by the interrupted cutting action by teeth on the blade from the moment in which the cutting disk comes into contact with the surface of the metal bar up to the moment in which the cut is completed in the cut-off unit. Therefore, in order to reduce the vibrations, the ideal solution would be a blade with an infinite number of cutting edges so that there would be no interruptions.

From a practical point of view, this solution would not be possible because the cutting speed would have to be too high. In spite of this, it is safe to say that ideal cutting conditions are closely reached when the number of teeth is increased, while being compatible with cutting speed.

However, it is also important to consider that a high number of teeth reduces the space or gap between one tooth and another. There becomes a risk that chips will accumulate in these gaps with an excessive volume of material. These conditions give rise to friction between the blade, teeth and chips, which leads to excessive wear of the blade.

For example, during the cutting phase of a solid metal bar with the blade rotating at a constant speed, any one tooth of the blade cuts arcs of material into chips with varying lengths. When the cutting phase is at the beginning, small arcs of material are cut. When the cutting phase is at the center of the metal bar, the largest arcs of material are cut. It is clear that the material accumulated between one tooth and another will be either more or less, respectively, at the center (contact arc between the blade and piece to be cut is large) and at the beginning (contact arc between the blade and piece to be cut is small). The same conditions are obviously found when cutting a tubular piece of material.

In view of the above considerations, it is clear that one way of eliminating the variation in the chip volume accumulated in the gaps is to reduce or increase the advancement speed of the shaft of the cutting machine holding the cutting disk, while keeping the cutting speed, that is the rotation speed of the cutting disk, constant.

Therefore, in a machine tool with a traditional cut-off unit, which is the type most commonly found, the advancement speed of the shaft is kept constant. On the other hand, in more advanced types of equipment, the metal bar is cut in steps, usually three, according to the point in which the metal bar is to be found.

Generally speaking, it maybe said that traditional solutions are still a long way from optimum cutting conditions. The conditions are somewhat limited, since they must satisfy the requirements mentioned previously. There is a compromise between safeguarding the working life of the blade and being penalized by the waste of time required to carry out the cutting or shearing.

To sum up, the prior art cut-off units do not achieve the result of reducing the time required for cutting as much as possible compared with a determined wear level of the cutting disk, which may be considered normal for the working life of the blade.

In consideration of the above, it seems quite clear that alternative and more functional solutions compared with those available or deduced up until now must be found.

The aim of this invention is, therefore, to offer the market a solution which gives greater satisfaction to the buying public.

These and other aims are achieved by the present invention, according to the characteristics in the attached claims, by solving the problems described herein.

### BRIEF SUMMARY OF THE INVENTION

The present invention is a cut-off unit with constant chip volume cutting for machine tools. The cut-off unit maintains a constant chip volume during cutting, which stabilizes friction between the blade of the cutting disk, the teeth of the cutting disk and the chips in between the teeth. In this manner, the working life of the blade and the speed metal bars at the cut-off unit can be controlled for extending the working life of the blade and for increasing the efficiency of time required for cutting or shearing at the cut-off unit. The cut-off unit includes a cutting tool, advancement device, and a logic control unit. During the cutting or shearing of a metal bar by the machine tool, the advancement speed of the cutting tool is guided by a logic-control unit and is continuously and regularly adapted to keep the volume of chip removed and accumulated in each of the gaps between the teeth constant. When cutting a metal bar, the advancement speed is higher at the start and at the end, and the advancement speed is lower in the middle of the cutting or shearing.

In this way, the significant creative contribution of the inventor leads to immediate technical progress, reaching various objectives described herein.

First, the time required for cutting or shearing is considerably reduced compared with the use of standard equipment. Furthermore, the reduction in the time required for cutting or shearing is achieved with any diameter blade for cutting or any diameter bar to be cut.

It is now possible to have a machine with a high technological content and with a system which is able to reduce the time required for cutting, while keeping as close as possible to the optimum cutting conditions and, consequently, obtaining a longer working life of the blade compared with previous solutions.

These and other advantages will be shown in the following detailed description and attached drawings of at least one preferential application of the solution, the details of which are intended to be an example and not a limitation. BRIEF DESCRIPTION OF THE SEVERAL VIEWS OF THE DRAWINGS

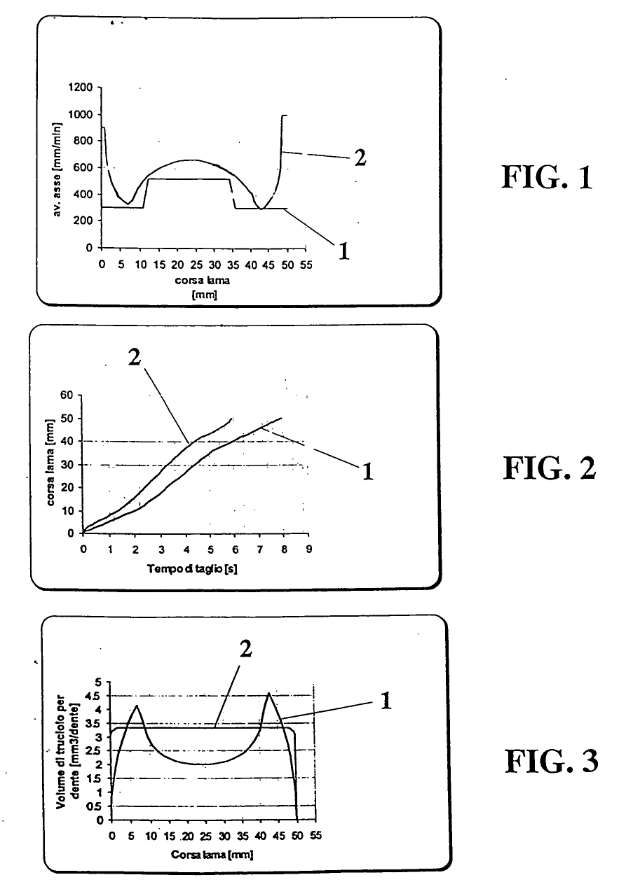

FIG. 1 is a graph illustration which represents the comparison between the cutting or shearing in a prior art standard cut (1) and the cutting or shearing of the present invention (2). The movement of the cutting tool is represented herein. The analysis was carried out by cutting a 50 mm diameter tube with a wall thickness of 8 mm.

FIG. 2 is another graph illustration which represents the comparison between the cutting or shearing in a prior art standard cut (1) and the cutting or shearing of the present invention (2). The time required for the cutting or shearing is represented herein. The analysis was carried out by cutting a 50 mm diameter tube with a wall thickness of 8 mm.

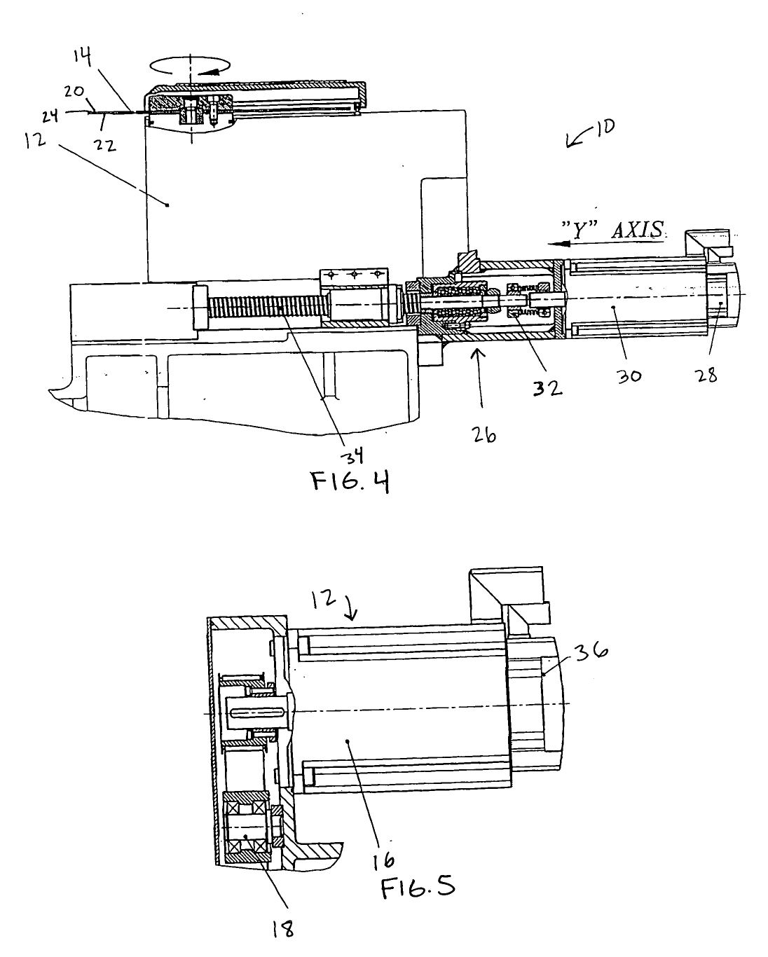

FIG. 3 is yet another graph illustration which represents the comparison between the cutting or shearing in a prior art standard cut (1) and the cutting or shearing of the present invention (2). The volume of chip accumulated inside each gap is represented herein. . The analysis was again carried out by cutting a 50 mm diameter tube with a wall thickness of 8 mm.

FIG. 4 is a sectional view of the cut-off unit of the present invention.

FIG. 5 is another sectional view and elevation view of the cut-off unit of the present invention.

### DETAILED DESCRIPTION OF THE INVENTION

With reference to the illustrations, it is shown that the aim of the invention is to allow the advancement speed of the cutting machine shaft to be varied, in order to keep the volume of chip cut away by each tooth constant.

As shown in FIG. 4, the present invention is a cut-off unit 10 with constant chip volume cutting for a machine tool. There is a cutting tool 12 having a cutting disk 14, spindle motor 16 and a gearbox 18. The cutting disk 14 has a blade 20 and a plurality of teeth 22. The teeth 22 set the number of cutting edges on the blade 20. As the cutting disk 14 rotates and as a metal bar is brought into contact the cutting disk 14, each tooth 24 cuts a chip (not shown) of metal material from the metal bar in the cutting or shearing of the metal bar. Each chip has a volume, and the present invention regulates chip volume such that each tooth 24 cuts a constant volume of chip. The cutting disk 14 is connected to the spindle motor 16 and the gearbox 18, such that the rotation speed of the cutting disk 14 is set by the spindle motor 16 and the gearbox 18. There is also an rpm encoder 36 on the cutting tool 12 to control rpm speed of the cutting disk 14.

The present invention also includes an advancement device 26 having an axial encoder 28, a brushless motor 30, a coupling 32 and a ball screw 34. The advancement device 26 is aligned on a Y-axis, such that all parts of the advancement device 26 are in alignment. The advancement device 26 is also connected to the cutting tool 12, such that the movement of the cutting tool 12 along the Y-axis is controlled by the advancement device 26. This Y-axis movement of the cutting tool 12 is advancement movement of the blade 20 and each tooth 24 towards the metal bar being cut by the cut-off unit. Thus, advancement speed of blade 20 and each tooth 24 can be controlled. The brushless motor 30 uses the coupling 32 to control the Y-axis movement of the ball screw 34. The movement along the ball screw 34 corresponds to the movement of the cutting tool 12 towards the metal bar and through the metal bar.

Importantly, the present invention has a logical control unit (not shown) in communication with the axial encoder 28 of the advancement device 26 and the cutting tool 12. The cutting tool 12 moves along vertical axis actuated by the brushless motor 30 fed back by information from an “optical provider” received through the logical control unit to control the displacement of the cut-off unit against the material to be machined. Similarly, the circular axis of the cutting disk 14 is actuated by the fed back and servo-ventilated spindle motor 16, which enables control of the rpm / torque of the blade 20 in communication with the rpm encoder 36. The control by the logical control unit provides a constant torque and rpm reference throughout the cutting or shearing. The rpm encoder 36 in communication with the spindle motor 16 and logical control unit continuously monitors spindle motor rpm to assure a regular rotation. In this way, the logical control unit guides the advancement speed of the cutting tool 12, such that the advancement speed is continuously and regularly adapted. The logical control unit also controls the rotation speed of the cutting disk 14. Therefore, the volume of a chip accumulated in each gap between each tooth 24 of the blade 20 is constant.

With regard to the logical control unit, the first consideration to be made is that the volume of chip which is cut away by each tooth 24 of the blade 20 is measured in [mm³/tooth], and the equation used, which is stored in the logic-control unit of the machine tool, is schematically shown below:
q=ARC×S×az
where, q=the volume of chip accumulated between two teeth of the blade [mm³/tooth]; ARC=the arc which results from the intersection between the average circumference of the blade and the circular piece of metal bar to be cut (mm); S=thickness of the disk (mm); and Az=advancement per tooth 24 of the blade 20 of the cutting unit 12 (mm/tooth).

As far as the thickness of the cutting disk 14 is concerned, this is a known value since it may be assumed that, in relation to the operation to be carried out, the cutting disk 14 to be used has already been chosen.

The intersection arc is found by means of a mathematical relationship obtained through the equation of the circumference of the blade 20 and the circumference of the round bar to be cut, according to the point in which the blade 20 is to be found inside the bar. In this way, the equation ARC=f(x) is obtained, where x is the position of the blade. In this case, x=“0” with the blade at the start of the cut, and x=“bar diameter” with the blade at the end of the cut.

The volume of chip cut away, “q”, which must remain constant, is calculated by assuming that the blade is in a maximum cutting condition, that is, on the diameter of the solid bar (or, in the case of a tube, inside the wall of the tube with the blade at a tangent with respect to the hole). Under these conditions, the value which represents the advancement per tooth “az” is introduced and “q” is calculated according to the previous equation.

According to the diameter of the bar to be cut, a sample of various points along the cut is created, from “O” up to the point in which the diameter of the bar is reached, and the following formula is applied:
az=q/(ARC×S)

The real advancement, in order to determine the movement of the cutting tool 12 of the cut-off unit 10, is given by the formula:
a=az×z×n
where: a=real advancement of the cut-off unit [mm/min]; z=number of cutting edges on the blade (known value); and n=rotation speed of the blade (revs/min) (known value).

The rpm encoder 36 is connected to the motor continuously monitors spindle motor rpm, to assure a regular rotation and hence compliance with the formula A=Az33 Z×RPM, indicated above.

The logical control unit uses a system based on PC processing and execution of a CNC Part Program. The CNC uses the Part Program to perform the following 3 actions:
1) controlling and commanding blade rpms;
2) programming torque on a blade transmission shaft; and
3) actuating displacement of the cut-off unit according to the constant shaving volume law.

The programming can be obtained in two ways. First, starting from the geometric data of the material to be processed (cut), from the blade, from the required advancement per tooth Az (mm/tooth) and from the cutting velocity Vc (m/min), the PC processes the data to generate a piece program (blade velocity and torque reference and cut-off unit displacement program).

| New Program | |
|---|---|
| No. teeth | x |
| Blade diameter/Bar diameter | (in mm) |
| Blade thickness | (in mm) |
| Feed for Tooth (Az) | (in mm/tooth) |
| Speed cut (Vc) | (in m/min) |

PC Elaboration then accounts for:
1) speed rotation for blade motor spindle;
2) torque limitation for blade spindle; and
3) feed positioning with speed profile.

A second way is starting from an archive of programs already executed previously, or retrieving a program from another machine equipped with the programming, without any processing since the data is 100% compatible (the same program can be reproduced with the same advancement and cutting speed values). For example, a Part Program Archive can be saved according to the values presented therein, such as:
Part Program Archive
Program # 1
Program # 2
Program # 3
Program # ?
Program N

The archived programs also account for:
1) speed rotation for blade motor spindle;
2) torque limitation for blade spindle; and
3) feed positioning with speed profile.

We claim:

1. A cut-off unit with constant chip volume cutting for a machine tool, the machine tool being used in the automatic machining of tubular and solid metal bars, said cut-off unit comprising:
a cutting tool having a cutting disk, spindle motor, a gearbox and an rpm encoder, said cutting disk being comprised of a blade and a plurality of teeth, said teeth setting the number of cutting edges on said blade, said cutting disk having a rotation speed set by said spindle motor and said gearbox, said rpm encoder in communication with said spindle motor;
an advancement device having an axial encoder, a brushless motor, a coupling and a ball screw, said advancement device being aligned on a Y-axis and being fixedly connected to said cutting tool; and
a logical control unit in communication with said axial encoder of said advancement device and said cutting tool, said logical control unit having the following values are known:
z=number of cutting edges on the blade;
n=rotation speed of the blade (revs/min); and
az=advancement speed per tooth (mm/tooth);
wherein advancement speed of said cutting tool is guided by said logical control unit, said advancement speed being continuously and regularly adapted, wherein volume of a chip accumulated in each gap between each tooth of said blade is constant, and wherein said advancement speed is set by the following formula:
a=az×z×n
with: a=real advancement of the cutting tool [mm/min].

2. A cut-off unit according to claim 1, wherein said logical control unit sets advancement per tooth of the cutting tool by the relationship:
az=q/(ARC×S)
where:
q=the volume of chip accumulated between two teeth of the blade [m³/tooth];
ARC=the arc which results from the intersection between the average circumference of the blade and the circular piece to be cut (mm);
S=thickness of the disk (mm); and
az=advancement speed per tooth of the shaft of the cut-off unit (mm/tooth).

3. A cut-off unit according to claim 1, wherein said logical control unit sets volume of chip cut away by each tooth of the blade in [mm³/tooth]is given by:
q=ARC×S×az

4. A cut-off unit according to claim 1, wherein said logical control unit sets advancement speed of the cutting tool by keeping volume of chip accumulated in each gap between the teeth of the blade constant, when cutting a bar, advancement speed being higher at a beginning and at an end, and lower in a middle.
